(19) United States
(12) Patent Application Publication
(10) Pub. No.: US 2014/0097304 A1
(43) Pub. Date: Apr. 10, 2014

(54) SLANTED BOLSTERING DEVICE FOR PIPE SUPPORT SYSTEM

(71) Applicant: Ronald J. Mastro, Fresno, CA (US)

(72) Inventor: Ronald J. Mastro, Fresno, CA (US)

(21) Appl. No.: 13/788,304

(22) Filed: Mar. 7, 2013

Related U.S. Application Data
(60) Provisional application No. 61/711,898, filed on Oct. 10, 2012.

(51) Int. Cl. F16L 3/12

(52) U.S. Cl. CPC F16L 3/12
USPC 248/73; 29/428

(57) ABSTRACT

The present invention is a pipe support system including a slanted bolstering device or arrangement, which receives and supports at least one exposed pipe, so as to isolate the pipe to prevent transmission of movement, sound or heat. Embodiments of the slanted bolstering device are designed to be attached to a strut support or mounting rail, and may include a pair of lateral bolstering clamps, and a circular pipe isolator. Embodiments of the invention also include a series of lateral bolstering clamps that may be mounted on the same strut support or mounting rail, providing even greater stabilization, and an organized system for mounting multiple pipes of different sizes. The present invention mitigates the effects of shifting or settling movement of the structure and provides additional shock absorption, prevents pipe rupture, and increases cushion protection among pipes of different sizes that may be mounted on a strut support.

This application claims the benefit of U.S. Provisional Application No. 61/711,898, filed on Oct. 10, 2012, which is incorporated herein by this reference in its entirety.

### BACKGROUND OF THE INVENTION

1. Field of the Invention

The present invention relates generally to pipe support systems used in building construction, and, more specifically, to a new and improved slanted bolstering arrangement or device that allows greater stabilization, and an organized system for mounting multiple pipes of different sizes.

2. Description of the Related Art

A variety of conventional devices are available for fastening or anchoring a pipe on a support. Most conventional clamping or fastening devices present numerous problems. Typically, these clamping devices consist of fastening means that encircle the pipe and are mounted on to the support surface by screws, bolts, or other fasteners. The pipe is in direct contact with the support surface, which causes significant problems such as pipe rupture when there is movement of the structure as a result of such things as earthquakes or other shifting and settling movement.

Applicant's prior U.S. Pat. No. 5,261,633, issued Nov. 16, 1993, solved some deficiencies of the conventional devices. However, the pipe support system described in Applicant's prior U.S. Pat. No. 5,261,633 does not disclose a slanted bolstering feature having four points of contact, and therefore does not provide additional stability and shock absorption to the overall pipe support system in the event of an earthquake or other disrupting impacts or movements.

There continued to be a need, therefore, for improvements in the pipe support arts in order to mitigate disruptive effects (e.g., rupture, deformation, leaking, disconnection, etc.) of the previously described situations.

### SUMMARY OF THE INVENTION

The present invention provides a slanted bolstering device or arrangement in a pipe support system, which receives and supports at least one exposed pipe. Embodiments of the slanted bolstering devices of the present invention include a strut support or mounting rail, a pair of lateral bolstering clamps, and a circular pipe isolator. Multiple bolstering devices of the present invention may be mounted on the same strut support or mounting rail, providing even greater stabilization, and an organized system for mounting multiple pipes of different sizes. Alternative embodiments allow for mounting single pipes.

It is therefore an object of the present invention to provide a slanted bolstering device that includes a slanted locking arrangement having four points of contact to further increase the stability of a pipe support system, as well as additional shock absorption from any disruptive impacts or shifting movement of the structure, such as those caused by earthquakes.

It is also an object of the present invention to provide a preferably circular pipe isolator that separates the pipe from the strut support, further providing additional stabilization and shock absorption when there is a movement of the structure as a result of earthquakes or other shifting and settling movement. In some embodiments, such pipe isolators have holes of various diameters for receiving pipes of different sizes. In other embodiments, the pipe isolators may be provided in different colors to help designate different sizes or types of pipes.

It is a further object of the present invention to provide a plurality of slanted bolstering devices or arrangements for holding a plurality of circular pipe isolators for mounting multiple pipes, which may be of different sizes.

It is a further object of the present invention to provide support devices or arrangements for holding a single circular pipe isolator for mounting a single pipe.

Additional objects of the invention will be apparent from the detailed description and the claims herein.

### BRIEF DESCRIPTION OF THE DRAWINGS

FIG. 1 is a perspective exploded view of an embodiment of a bolstering device of the present invention having lateral bolstering clamps.

FIG. 2 is a top view of the embodiment of a bolstering device of FIG. 1 showing upper and lower receptacle edges.

FIG. 3 is a side view of the embodiment of a bolstering device of FIG. 1 showing upper extensions and slanted lower extensions.

FIG. 4 is an end view of the embodiment of a bolstering device of FIG. 1 showing the slanted lower extension which includes upper and lower locking edges.

FIG. 5 is a perspective view of an embodiment of a single assembled, mounted bolstering device of the present invention on a strut support.

FIG. 6 is a top view of the embodiment of a bolstering device of FIG. 5.

FIG. 7 is a side view of the embodiment of a bolstering device of FIG. 5.

FIG. 8 is an end view of the embodiment of a bolstering device of FIG. 5, showing upper and lower locking edges.

FIG. 9 is a perspective view of multiple bolstering devices of the present invention mounted on a single strut support.

FIG. 10 is a top view of the multiple embodiments of FIG. 9.

FIG. 11 is a side view of the multiple embodiments of FIG. 9.

FIG. 12 is an end view of the multiple embodiments of FIG. 9, showing the slanted lower extension, which includes upper and lower locking edges.

FIG. 13 is a perspective view of multiple alternative embodiments of bolstering devices of the present invention mounted on a single strut support.

FIG. 14 is a top view of the multiple embodiments of FIG. 13.

FIG. 15 is a side view of the multiple embodiments of FIG. 13.

FIG. 16 is an end view of the multiple embodiments of FIG. 13, showing the slanted lower extension, which includes upper and lower locking edges.

FIG. 17 is a perspective and exploded view of an alternative embodiment of the present invention.

FIG. 18 shows different views of the mounting structure of FIG. 17.

FIG. 19 is a perspective and exploded view of an alternative embodiment of the present invention.

FIG. 20 shows different views of the mounting structure of FIG. 19.

### DETAILED DESCRIPTION

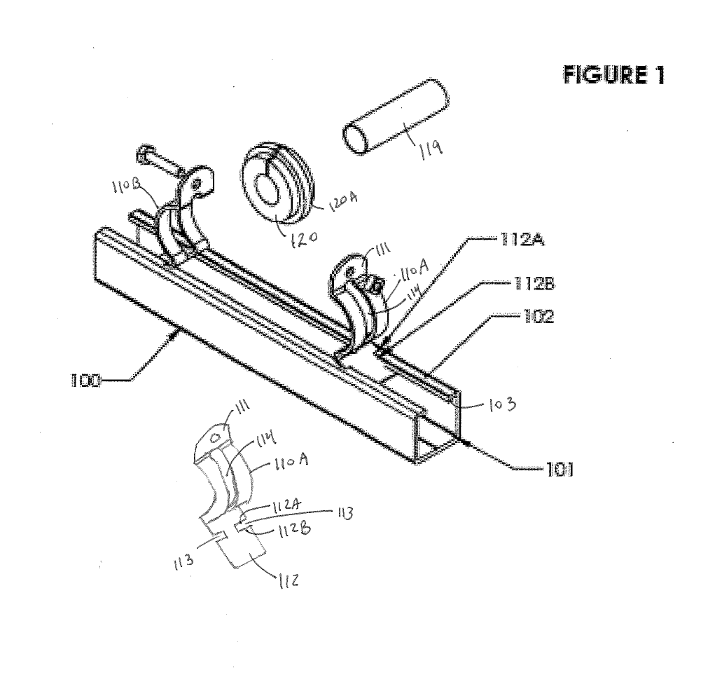

Referring to the drawings wherein like reference characters designate like or corresponding parts throughout the several views, and referring particularly to FIGS. 1-3, it is seen that this illustrated embodiment of the invention is mounted on a strut support or rail 100, and includes a two-piece lateral bolstering clamp 110A 110B, and a pipe isolator 120.

The strut support or mounting rail 100 may comprise a rigid material such as steel, aluminum, or structural plastics (e.g., polycarbonates, polyvinylchloride [PVC], acrylonitrile butadiene styrene [ABS], etc.). In some embodiments, the strut support or mounting rail 100 may include a material that is both rigid and has high resilience (e.g., medium to high carbon steel, spring steel, etc.), so that it can absorb energy during a an earthquake or some other shock or impact that causes movement in the pipe mounting system. The absorption of such energy will reduce the amount of energy and stress exerted on the pipes connected thereto.

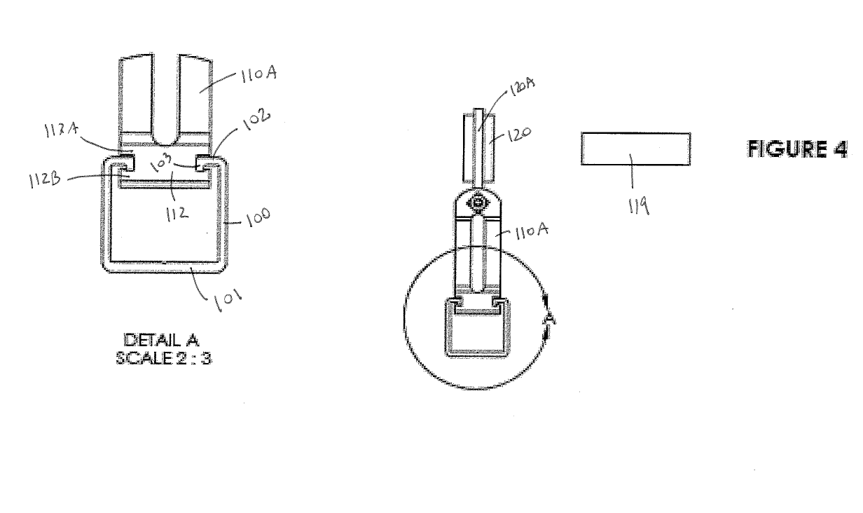

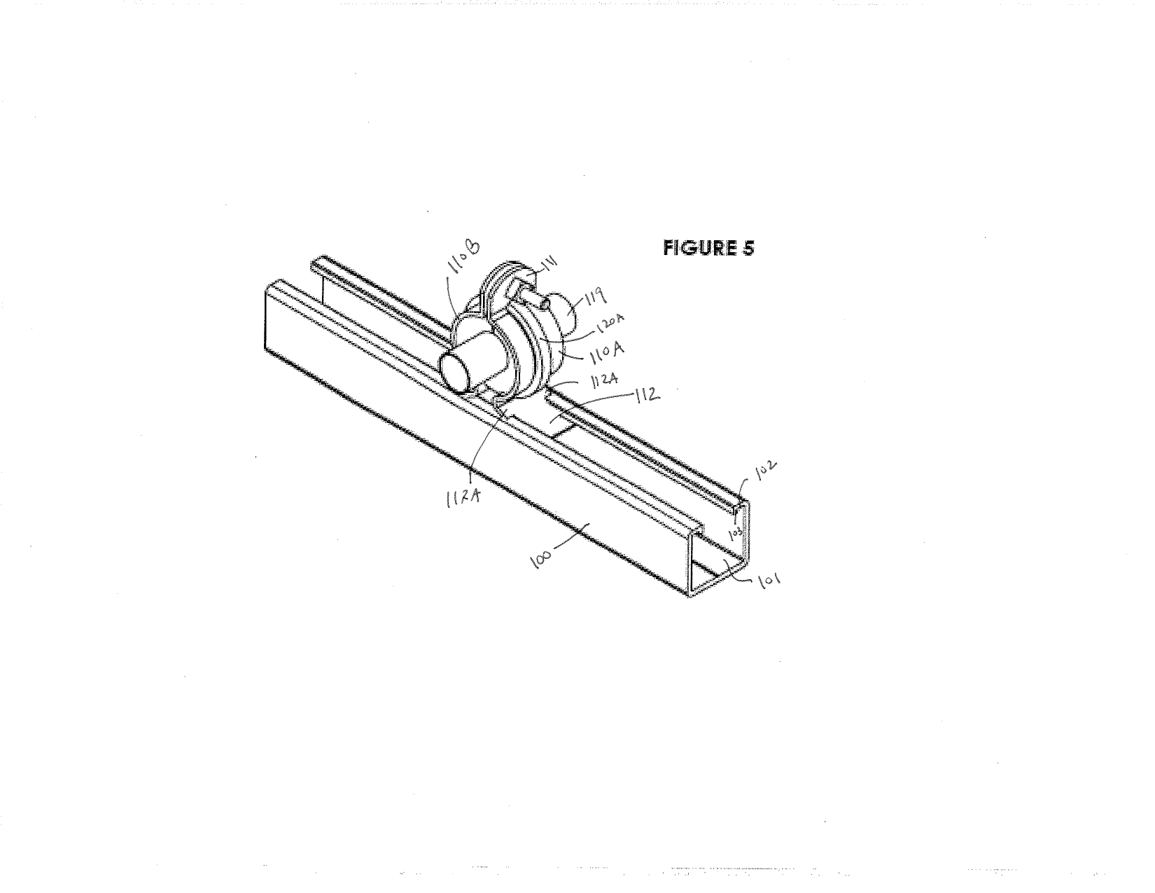

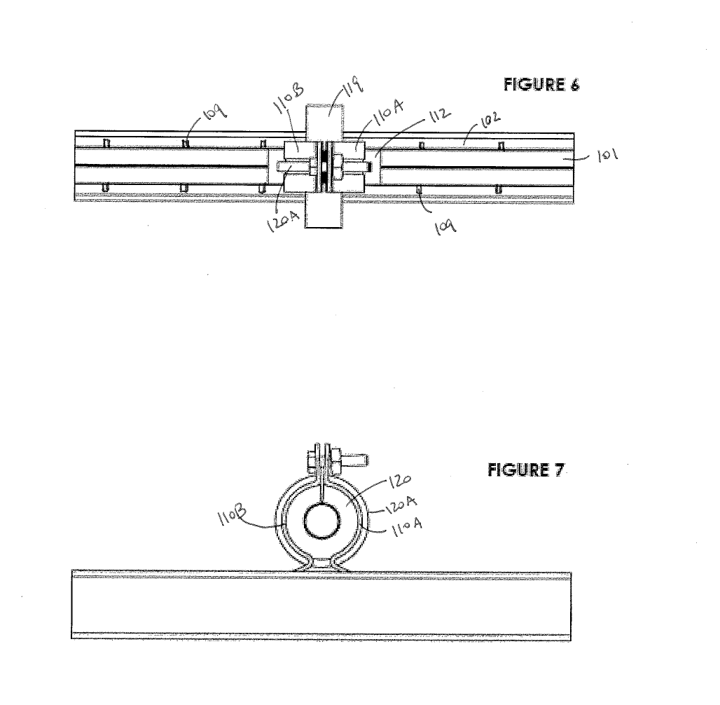

The strut support or mounting rail 100 has a rectangular (e.g., square) cross-section, with a base with a planar lower surface 101 and an open upper surface having a pair of lips or flanges 102 along its length. The lips or flanges may each have two planar portions, a first planar portion that is generally parallel to the base 101 of the strut support or mounting rail 100, and a second planar portion 103 that is generally perpendicular to portion 101 and protrudes into the opening from the first planar surface (see, e.g., FIG. 4). The second planar portion may protrude from the end of the first portion surface, as shown in FIG. 4. In some embodiments, the second planar portion may protrude from a bottom of the first planar portion to form a T-shaped lip or flange. In other embodiments, the second planar portion may protrude into the opening at various angles from the first planar portion ranging from about 10° to about 170° (and in some embodiments, from about 30° to about 60°, from about 40° to about 50°, or any value or range of values therein). In another embodiment, the lips or flanges 102 may have a single planar portion having a sufficient thickness to effectively engage upper and lower locking edges 112A and 112B of a pair of lateral bolstering clamps 110 (see, e.g., FIG. 1). In other embodiments, an edge of the lips or flanges 102 and/or 103 protruding into the opening may have a semi-circular, polygonal, or other shape for engaging complementary structures or openings on the lateral bolstering clamps 110. It is to be appreciated that slots 113 in the slanted lower clamp extension 112 have shapes that correspond to the shape of the lips or flanges 102.

The upper lips or flanges 102 of the strut support include upper and lower receptacle edges (102A and 102B) at the ends of the first and second planar portions, respectively. The upper and lower edges 102A and 102B of the upper lips or flanges 102 may be designed for receiving the upper and lower locking edges 112A and 112B of slots 113 of portions 112 of the lateral bolstering clamps 110 of embodiments of the present invention. In addition to engaging the edges 102A and 102B of flanges 102, locking edges 112A and 112B may also engage flange 103. It is to be appreciated that the shape of slot 113 may be provided in a form that is complementary to flange 102 and/or flange 103 to provide secure engagement therewith, and that any suitable complementary shape may be used including without limitation, an L-shape, T-shape, U-shape, V-shape, J-shape, etc. The lips or flanges 102 and 103 may include additional layers or materials deposited or added thereon (particularly on edges 102A and 102B) to increase friction and grip between these flanges and the edges 112A, 112B of slots 113 of bolstering clamps 110. For example, a compressible material such as rubber (e.g., natural rubber, butyl rubber), vinyl, nitrile, or silicone can be added over or onto the upper and/or lower edges of flanges 102, 103, 102A and/or 102B.

The supporting strut or rail 100 may also include notches 109 in the lips or flanges 102 for receiving and further securing the upper and lower locking edges 112A and 112B of the lateral bolstering clamps 110. (See FIG. 6.) The notches 109 are preferably be provided in pairs, across from each other on flanges 102 and/or 103, and may be spaced at regular intervals (e.g., every ¼ inch, every ½ inch, etc.). It is to be appreciated that in some embodiments, the depths of slots 113 may be smaller, or slots 113 may be eliminated, for better engagement with notches 109.

In most embodiments, slots 113 are mirror images of each other. However, in other embodiments, slots 113 may be different from each other, and not necessarily directly across from each other on extension 112. For example, and without limitation, in some embodiments, a first slot 113 may be provided on one side of extension 112, but not on the other; or the location, depth, size and/or shape of a first slot 113 on one side of extension 112 may be different from the location, depth, size and/or shape of a second slot 113 on the other side of extension 112. Similarly, in most embodiments, flanges 102 and 103 are mirror images of each other. However, in other embodiments, flanges 102 and 103 may be different from each other, and have different shapes. For example, and without limitation, in some embodiments, a first flange 102 on one side of strut 100 may have a first length, width or shape, but a second flange 102 on the other side of strut 100 may have a different length, width or shape. Similarly, a first flange 1033 on one side of strut 100 may have a first length, width or shape, but a second flange 103 on the other side of strut 100 may have a different length, width or shape. It is to be appreciated that whatever sizes, shapes or dimensions are chosen for slots 113 and flanges 102/103, they should be complementary to provide frictional engagement and support.

In some embodiments, there may be measuring indicators on the supporting strut or rail 100 (e.g., on outside surfaces of the side walls of the supporting strut or rail 100). For example, distance measurements (e.g., in English or metric units) can be imprinted, etched, or attached (e.g., an attached sticker) on the sidewalls of the supporting strut or rail 100. The measurement indicators can facilitate alignment of the bolstering clamps between adjacent supporting struts. For example, where a pipe is supported by multiple slanted bolstering clamps on multiple supporting struts across a large room, the measuring indicators may facilitate quick alignment and installation, while preventing misalignment and consequent flexion in the pipe, which may contribute to rupture, leaking, or disconnection of the pipe.

In preferred embodiments, each slanted bolstering clamp 110 is made of two lateral mirror-image pieces (lateral bolstering clamps), each piece including a semi-circular central area, an upper extension 111, and a clamp extension 112 with slots 113 on opposite sides for engaging the lips or flanges 102 and/or 103 at the upper and lower receptacle edges 102A and 102B. The upper extension 111 of each bolstering clamp 110 may include a planar surface with one or more holes for receiving bolts and other fastening devices therein, and may be joined to a corresponding upper extension 111 of the mirror-image piece of the clamp using any suitable means, such as a nut and bolt assembly, a clip, locking pins, etc.

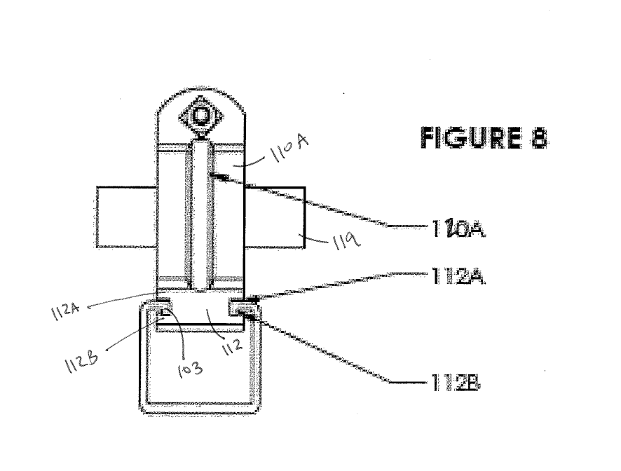

The semi-circular central areas of clamps 110 may form an annular structure for receiving a pipe isolator 120 when two mirror-image bolstering clamps are installed on the strut support 100 (see, e.g., FIGS. 1 and 3). In some embodiments, the semi-circular central areas may be provided with an inner opening 114 (e.g., a slot running down the middle of semi-circular central areas) for receiving a corresponding extension 120A of a pipe isolator 120 (see FIGS. 1 and 8). The annular ring may be oriented in parallel with the supporting strut or rail 100, such that a pipe 119 that is inserted through the annular ring runs perpendicular to the supporting strut or rail 100. In some embodiments, the semi-circular central areas of the lateral bolstering clamps 110 may be provided an oblique angle (e.g., a range from about 1° to about 89°, or any angle or range of angles therein), such that when the lateral bolstering clamps are articulated to form an annular structure, the annular structure is at an oblique angle to the length of the supporting strut or rail 100.

In further embodiments, the central areas of the lateral bolstering clamps 110 may have a shape other than a semi-circle. For example, the central areas of the mirror-image bolstering clamps 110 may have shapes that, when paired, form an ellipse, a rectangle, a square, a triangle, a trapezoid, a hexagon and other polygonal shapes, a cross, a star, a squircle, Reuleaux shapes, and various other shapes. In such embodiments, the pipe isolator 120 may have a corresponding shape to allow for a tight fit between the pipe isolator 120 and the paired mirror-image bolstering clamps 110.

Each clamp piece also includes a slanted lower extension 112 for engagement with the flanges 102 of the strut 100. The lower extensions 112 of each clamp piece include a pair of slots 113 which define upper and lower locking edges 112A and 112B. The slots 113 of each clamp extension 112 are designed to receive the flanges 102 and/or 103 on opposite sides of strut 100. Thus, the shapes of the slots correspond to the shape of the lips or flanges 102 and/or 103, including the upper and lower receptacle edges 102A and 102B. The slanted orientation of each extension 112 provides at least four points of contact between the upper and lower locking edges of the extension (112A and 112B) and the upper and lower flange edges (102A and 102B). Two points of contact are obtained by each of the two slots 113 for a total of at least four points of contact. In other embodiments, slots 113 and flanges 103 may have a complementary shape (e.g. T-shape) which provides for additional points of contact and additional support.

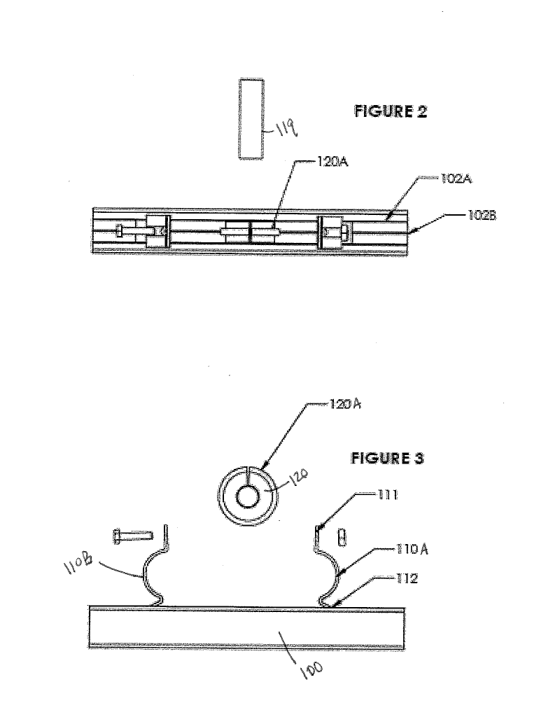

Referring the FIGS. 2 and 3, when the complete bolstering clamp is installed, the upper locking edge 112A of each lateral bolstering clamp 110 is directly in contact with the upper flange edge 102A. Furthermore, the lower locking edge 112B of the lateral bolstering clamp is directly in contact with the lower flange edge 102B. The slanted bolstering and locking arrangements of the upper and lower edges 112A and 112B to the upper and lower flange edges 102A and 102B, as described herein, further increase the stability of the pipe support system, and provide additional shock absorption from any disrupting impacts or shifting movement of the structure.

In embodiments where notches 109 are provided on strut 100, slots 113 may be more shallow than embodiments where no notches are provided, allowing the slots 113 and notches 109 to securely engage, and thereby provide increased frictional support. In some embodiments where notches 109 are provided on strut 100, slots 113 may be eliminated, and the four points of contact are obtained using the upper and lower surfaces of notches 109 when engaged against the slanted edges of lower extensions 112.

The slanted orientation of the lower extensions 112 also allows the slots to have a length that is greater than the thickness of the lips or flanges 102, facilitating easy installation of the lateral bolstering clamps 110. For instance, in one embodiment, the slot may have a length of about one inch, and the lips or flanges 102 may have a thickness of about ¼ inch. In this embodiment, when perpendicularly oriented relative to the lips or flanges 102, the slots can freely slide along the lips or flanges 102, allowing for easy installation of the lateral bolstering clamps 110. Subsequently, when two mirror-image lateral bolstering clamps 110 are secured to one another at the upper extensions 111, the angle of the slanted lower extension 112 relative to the supporting strut 100 (e.g., an angle in a range of about 10° to about 80°) results in a tight fit between the upper and lower locking edges of the extension (112A and 112B) and the upper and lower flange edges (102A and 102B). Thus, the slanted feature of the lower extension provides additional stability and shock absorption to the overall pipe support system, while allowing ease of installation.

The slots 113 of the slanted extensions 112 may have a rectangular shape corresponding to a rectangular shape of the lips or flanges 102. In some embodiments, the lips or flanges 102 may have an angled, rounded, or irregular shape, as explained above. In such embodiments, the slots 113 of the slanted extensions 112 may have a corresponding shape that allows the slots to tightly engage with the lips or flanges 102, when the two mirror-image lateral bolstering clamps are installed and secured to one another. For example, if the lips or flanges 102 have a semi-circular shape, the slots 113 may have an elliptical shape that allows each point along each slot to be in contact with the semi-circular lips or flanges 102.

The lateral bolstering clamps may be made from a single material, such as steel, aluminum, or structural plastics (e.g., polycarbonates, polyvinylchloride [PVC], acrylonitrile butadiene styrene [ABS], etc.). For instance, the lateral bolstering clamps may be made from sheet steel having a thickness in a range from about 0.005 inches to about 0.15 inches (e.g., about 0.01 inches to about 0.125 inches, or any value or range of values therein). In some embodiments, the lateral bolstering clamps 110 may include a material that is both rigid and has high resilience (e.g., medium to high carbon steel, spring steel, etc.), so that when the mirror image bolstering clamps 110 are installed on the strut support 100 to form a complete bolstering clamp, the clamp extensions 112 can be flexed to a limited extent without plastic deformation, and thereby exert pressure on the upper and lower receptacle edges 102A and 102B of lips or flanges 102. Such pressure may create a tighter fit, and further prevent movement between the movement between the bolstering clamps 110 and the supporting strut 100.

In embodiments in which the lateral bolstering clamps 110 comprise a resilient material, the slanted clamp extensions can be flexed when a stress is applied to an assembled bolstering clamp (e.g., shaking during an earthquake). The slanted clamp extensions may be at an angle of about 10° to about 80° (e.g., about 30° to 60°, or any value or range of values therein) relative to the supporting strut when the bolstering clamp is assembled, and may allow the slanted clamp extensions to flex slightly as the supporting strut is displaced (e.g., vertically displaced) during an earthquake or other disturbance, and thereby reducing the amount of stress applied to the pipe. Thus, the angle of the slanted clamp extensions may provide additional shock absorption and reduces stress on pipes that are supported by the bolstering clamps.

Additionally, the upper and lower locking edges of the clamp extension slots 113 (112A and 112B) may include additional layers or materials deposited or added over the material of the clamp extension 112 to increase friction and grip between the receptacle edges 120A and 102B and the locking edges of the clamp extensions 112A and 112B. For example, a compressible material such as rubber (e.g., natural rubber, butyl rubber), vinyl, nitrile, or silicone can be added over the edges of the clamp extensions 112A and 112B.

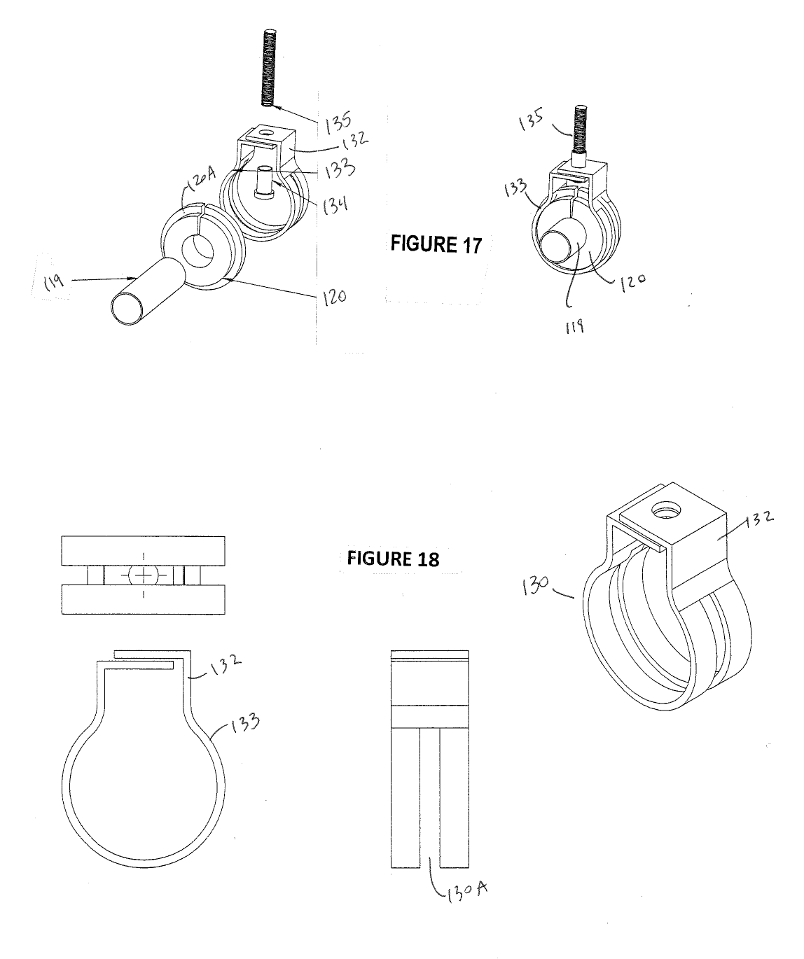

In some embodiments, the bolstering clamps may be a unitary piece of material having an attachment extension that can be attached to a supporting structure with a single threaded bolt or other fastener. As shown in FIGS. 17-18, the bolstering clamp 130 may have an annular portion 133 forming a nearly complete ring with a centrally located opening 130A (e.g., a slot) therein for receiving a corresponding extension 120A of a pipe isolator 120. The centrally located opening may run along the middle of the annular portion 133 and along all or part of the circumference of the ring. The bolstering clamp 130 may have an open area in the ring at the base of the annular portion 133. The open ends of the annular portion 133 may be continuous with lower extensions 312, which may be slanted or have a curvature. For example, the lower extension 312 may have slanted angle in a range from about 10° to about 80° (e.g., from about 30° to about 60°, 45°, or any value or range of values therein) relative to a supporting strut or other structure on which the slanted bolstering clamp 130 is mounted, or the lower extension may have a curvature of an arc length in a range of about 5° to about 90° (e.g., from about 10° to about 45°, 30°, or any value or range of values therein). The bolstering clamp 130 may also have an upper attachment portion 132 for attaching the bolstering clamp to a supporting strut or other structure. The upper portion 132 may have L-shaped extensions 132A and 132B that may have holes for threading a bolt, pin, or other fastening structure 135 therethrough. The holes of L-shaped extensions 132A and 132B may be overlapped so that a single bolt receiver 134, and/or bolt 135 may be threaded through both holes. For example, a bolt receiver or insert 134 may be threaded through both of the holes in the two L-shaped extension 132A and 132B, and a threaded member (e.g., bolt) 135 may then be engaged with the bolt receiver 134. The other end of the threaded member 135 may then be engaged with a supporting structure (e.g., a support strut, a metal or wood beam, etc.) to suspend the bolstering clamp 130.

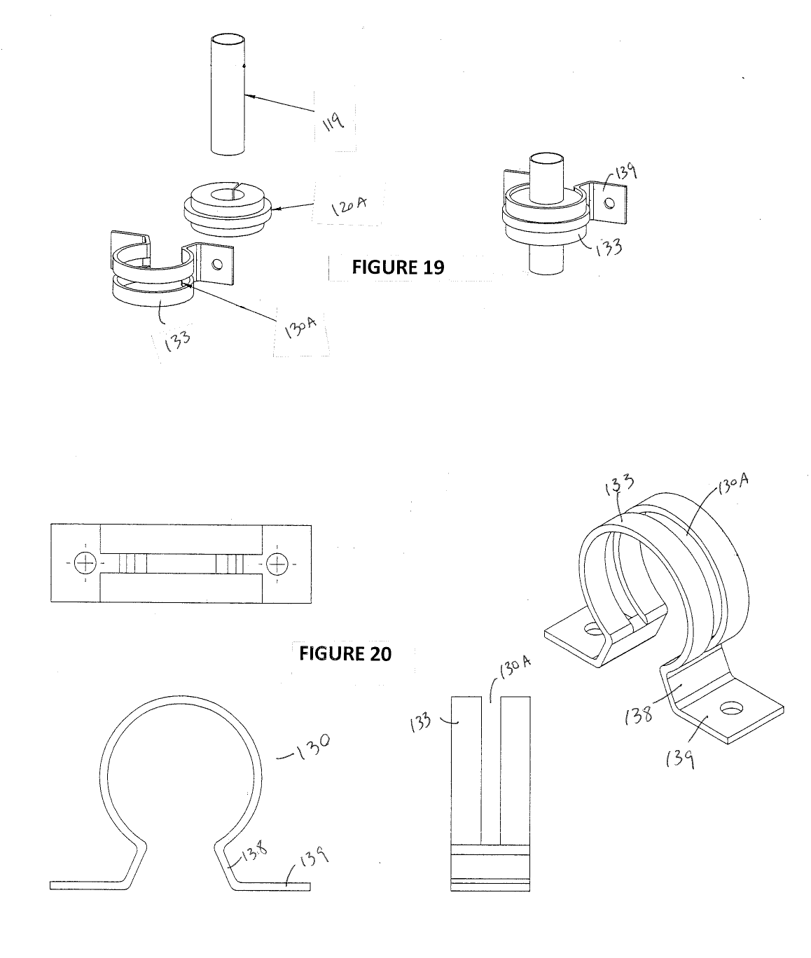

In some embodiments, slanted bolstering clamps may be a unitary piece of material having slanted extensions. As shown in FIGS. 19 and 20, the slanted bolstering clamp 130 may have an annular portion 133 forming a nearly complete ring. The slanted bolstering clamp 130 may have an open area in the ring at the base of the annular portion 133. The ring may have a centrally located opening 130A (e.g., a slot) therein for receiving a corresponding extension 120A of a pipe isolator 120. The centrally located opening 120A may run along the middle of the annular portion 133 and along all or part of the circumference of the ring. The open ends of the annular portion 133 may be continuous with slanted extensions 138. The angle of the slanted extension 138 relative to a supporting strut or other structure on which the slanted bolstering clamp 130 is mounted may be in a range from about 10° to about 80° (e.g., from about 30° to about 60°, 45°, or any value or range of values therein). The angled structure of the slanted extension may provide additional stability and shock absorption to the overall pipe support system. The slanted bolstering clamp 130 may also have lateral attachment extensions 139 for attaching the slanted bolstering clamps 130 to a supporting strut or other structure. The extensions 139 may have holes for threading a nut and bolt assembly, a locking pin, or other fastening structure therethrough. For example, a bolt (e.g., with a washer thereon) may be threaded through each of the holes in the two lateral extension 139, and the bolts may then be slotted into the opening of strut support 100. The bolts may be secured to the strut support 100 by nuts, wing nuts, or other fastening means that may be engaged with the bolts. In other examples, the slanted bolstering clamp 130 may be installed on another supporting structure such as a metal or wood beam.

As mentioned above, embodiments of circular isolator 120 may be provided for insertion between the curved edges 110 of the clamp pieces. In these embodiments, isolator 120 includes a central opening for receiving a pipe 119, and provides a cushion between a clamp of the present invention and the pipe 119. Isolator 120 is preferably made of a slightly deformable or rubberized material, but should also have sufficient strength to support pipe 119 (e.g., polyurethane foam, polystyrene foam, polyimide foam, silicone foam, polymerized chloroprene, natural rubber, butyl rubber, etc.). The material of the circular isolator 120 is also preferably flame retardant. For example, the circular isolator may completely or partially made from flame retardant silicone rubber. In some embodiments, the isolator may include a plurality of layers. For example, the isolator 120 may comprise a resilient form enclosed in an outer silicon rubber layer. In some embodiments, isolator 120 may be provided with a radial cut that allows a pipe 119 to be inserted therein, or it may be provided in multiple pieces that are formed together around a pipe 119 and then inserted into a clamp of the present invention.

In some embodiments of the invention, the circular isolator 120 may be provided with an extension 120A, which acts as a locking ridge or protrusion. The locking ridge 120A may be inserted into the inner openings 110A of the lateral bolstering clamps to securely hold the isolator 120 to the clamps and separate the pipe from the strut support. The locking ridge or protrusion may have various shapes, and may engage with one or both of the lateral bolstering clamps 110. The isolator locking arrangement and the slanted extension features provide support and lessen the effect of stress during earthquakes or other shifting and settling movement. By these features, the present invention provides additional support to a pipe support system, and increases cushion protection from impacts or other disruptive effects.

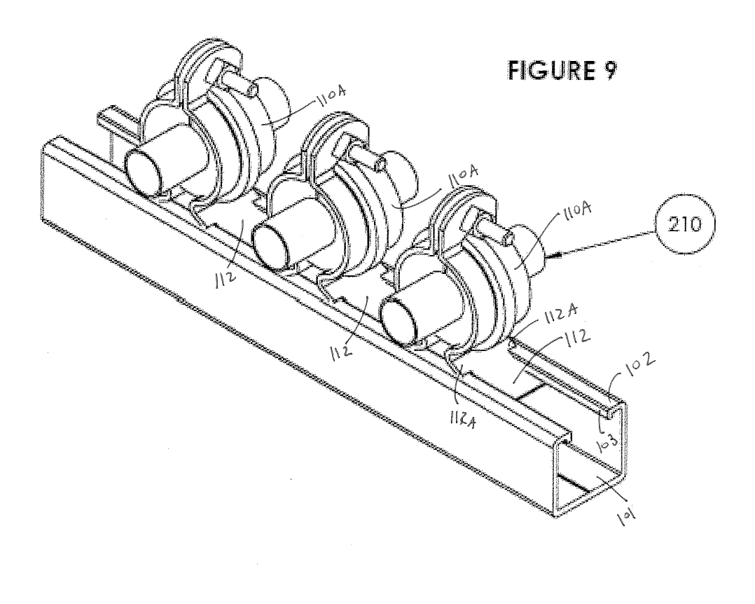

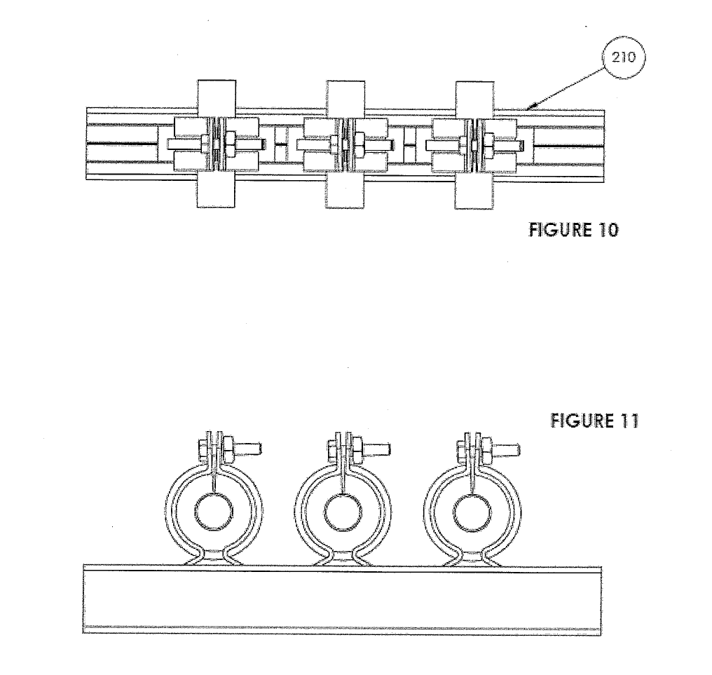

FIGS. 9, 10, and 11 disclose a series of embodiments of bolstering devices 210 of the present invention having a series of circular isolators for mounting multiple pipes to a single strut support. It is to be appreciated that different embodiments of the bolstering devices that have different sizes, shapes, and other features may be provided on a single supporting strut. The isolator locking arrangement of the locking ridge and the inner locking opening as described above, also provides additional stabilization and support to the overall pipe support system, separates multiple pipes from the strut support, and increases cushioning and protection of the pipes from disruptive impacts or shifting movement of a building. The circular isolators, including embodiments having the locking ridge, may be provided in different colors to help keep track of different sizes or types of pipes (e.g., hot water pipes, cold water pipes, natural gas pipes, etc.). The circular isolators can easily be installed, removed, or retrofitted to accommodate different sized pipes. For example, a bolstering device may have a sufficient size (e.g., it may have a circular section for receiving the circular isolator with a diameter of about 3 inches) to accommodate pipes in a range of diameters (e.g., from about ½ inch to about 2 inches). These features help mitigate the effects of shifting or settling movement of the structure and provide additional shock absorption and cushion protection among pipes of different sizes that may be mounted on the strut support.

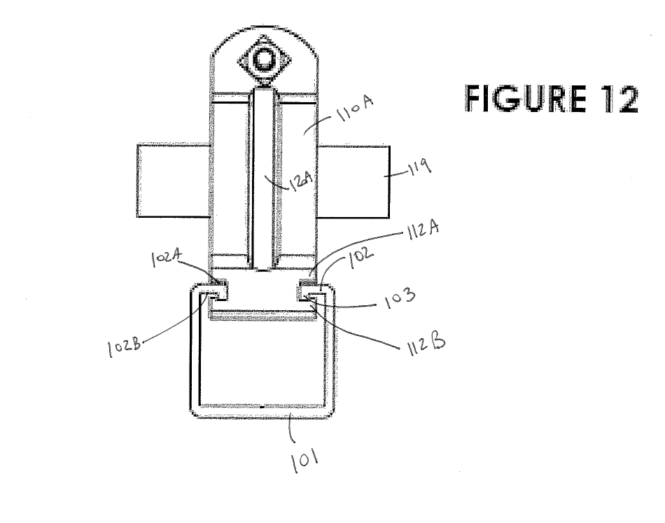

Multiple slanted bolstering devices having the isolator with a locking ridge or protrusion and slanted locking arrangements are provided as an alternative means for supporting a plurality of pipe systems, as shown in FIGS. 9-12. The supporting struts or rails may be of varying lengths and may accommodate many bolstering devices (e.g., from 1 to 100 bolstering devices). The grips between the upper and lower locking edges 112A and 112B of the slanted extensions 112 and the upper and lower receptacle edges 102A and 102B of the lips or flanges 102 are sufficient to maintain the positions of the multiple bolstering devices secured to the supporting strut or rail 100. Thus, the bolstering devices will remain in substantially the same position along the supporting strut or rail 100 during earthquakes or other shaking disturbances.

The bolstering clamps and supporting struts or rails of the present invention can be included in a larger pipe supporting system that includes a plurality of pipes and a combination of other pipe supporting structures (e.g., wall brackets and mounts). For example, the pipe supporting system may include multiple supporting struts or rails aligned across a large room or space, each supporting rail or strut having a plurality of the bolstering clamps that are aligned for receiving pipes of varying sizes.

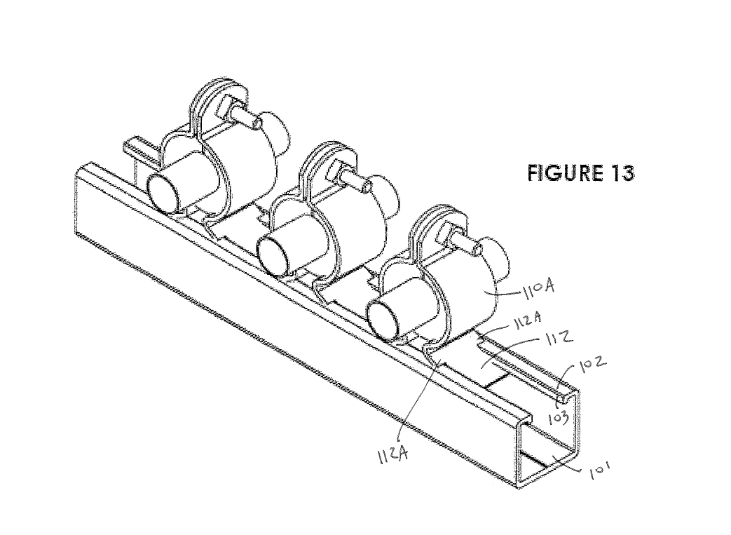

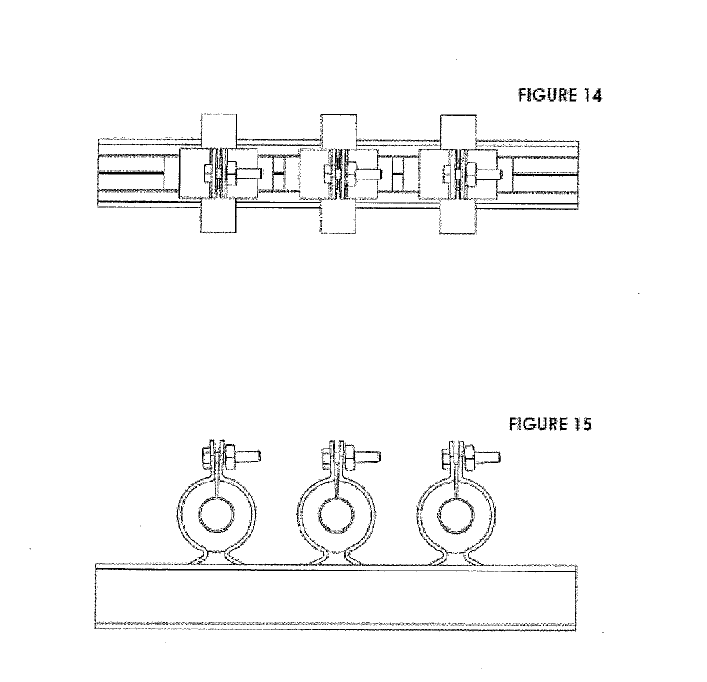

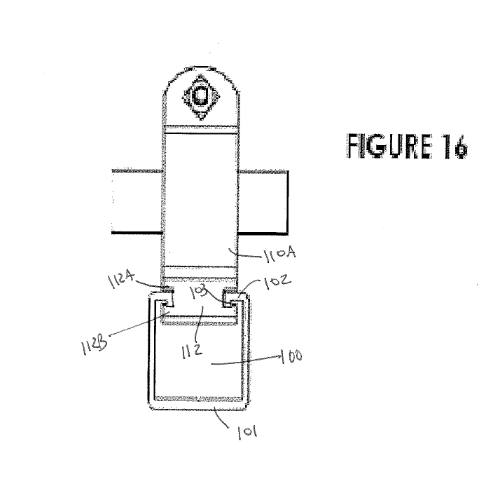

In some embodiments, the supporting strut or rail may support a plurality of slanted bolstering devices having the slanted locking arrangement without the isolator locking ridge in a pipe supporting system, as shown in FIGS. 13-16.

Thus, the present invention provides a slanted bolstering device or arrangement in a pipe support system for improving the stabilization and cushioning of suspended pipes, and methods of using and assembling the same.

The foregoing descriptions of specific embodiments of the invention are presented to illustrate and describe the invention. They are not intended to be exhaustive or to limit the invention to the precise embodiments disclosed. In particular, it is to be appreciated that different permutations and/or combinations of the various features described herein may be used in conjunction with other features described herein, all of which are within the scope of the present invention. The invention is not to be limited by the described embodiments which were chosen in order to explain the principles of the invention and its practical application, and to enable those skilled in the art to utilize the invention and including various modifications.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A support device for a pipe system comprising:
a clamp having two corresponding mirror-image clamp pieces, each such clamp piece including an upper extension for engagement with the upper extension of said corresponding mirror-image piece, a central pipe supporting section, and a lower slanted section, said lower section including a pair of slots, one on each side, for engagement with a pair of corresponding flanges on a support strut; and
a pipe cushion for insertion between the central pipe supporting sections of said clamp pieces, said cushion having a central circular opening for receiving a pipe.

2. The support device of claim 1, wherein the clamp is secured to the support strut by pressure and friction between edges of said pair of slots and said corresponding flanges.

3. The support device of claim 1, wherein the central pipe supporting section of each of said clamp pieces includes an opening, and said cushion includes an outer protrusion that fits into said opening.

4. The support device of claim 1, wherein said pipe cushion includes a radial cut from an outer edge to the central opening.

5. The support device of claim 1, wherein said lower slanted portion is at an angle of about 10° to about 80° relative to a planar structure on which said support device is mounted.

6. The support device of claim 1, wherein said lower slanted portion is at an angle of about 30° to about 60° relative to a planar structure on which said support device is mounted.

7. The support device of claim 1, wherein said pipe cushion comprises a deformable material.

8. The support device of claim 1 wherein a plurality of notches are provided on said flange of said support strut.

9. The support device of claim 1 wherein a second flange is provided on said flange, and said pair of slots are shaped to correspond to the shapes of said flange and said second flange.

10. The support device of claim 1 wherein said pair of slots have the same shape.

11. The support device of claim 1 wherein said pair of slots have different shapes.

12. A support device for a pipe system comprising:
a clamp having two corresponding mirror-image clamp pieces, each such clamp piece including an upper extension for engagement with the upper extension of said corresponding mirror-image piece, a central pipe supporting section, and a lower slanted section;
an elongated support strut having an upper and a pair of flanges on either side of said opening extending toward an interior thereof, each of said flanges having a plurality of notches thereon for receiving said lower slanted section of said clamp; and
a pipe cushion for insertion between the central pipe supporting sections of said clamp pieces, said cushion having a central circular opening for receiving a pipe.

13. The support device of claim 12 wherein said lower slanted section further comprises at least one slot for engagement with one of said plurality of notches.

14. The support device of claim 12 wherein said lower slanted section further comprises a pair of slots on opposite sides thereof for engagement with a corresponding pair of said plurality of notches.

15. A pipe support system comprising:
a. a rigid supporting member comprising an elongate opening running along the supporting member and flanges along said opening for engaging at least one pipe supporting member;
b. at least one pipe support, each support comprising two sides, each side having a pipe supporting portion and a slanted plate, the slanted plate having a pair of slots thereon for engaging said flanges to secure the pipe supports to the rigid supporting member; and
c. a pipe cushion for receiving a pipe in said at least one pipe support, the pipe cushion being held between the pipe supporting portions of each pipe support.

16. The pipe support system of claim 15 wherein said at least one pipe support is secured to the rigid supporting member friction between edges of said slots and said flanges.

17. The pipe support system of claim 15 wherein the pipe supporting portion of each of said pipe supports includes a second opening in said pipe supporting portion, and said pipe cushion includes an outer protrusion that fits into said second opening.

18. The pipe support system of claim 15 wherein said pipe cushion includes a radial cut from an outer edge to a central opening of the pipe cushion.

19. The pipe support system of claim 15 wherein said lower slanted portion is at an angle of about 10° to about 80° relative to the rigid supporting member.

20. A method of assembling a pipe support system comprising:
a. sliding a first side of a pipe support into a strut having an opening along its length and flanges along sides of said opening, the first side of the pipe support having a first slanted plate having first slots for engaging said flanges and a first pipe support portion;
b. sliding a second side of said pipe support into said strut, the second side of the pipe support having a second slanted plate having second slots for engaging said flanges and a second pipe support portion;
c. placing a pipe cushion between the first pipe support portion and the second pipe support portion, said pipe cushion having a circular hole for receiving a pipe; and
d. articulating the first pipe support portion and the second pipe support portion to form said pipe support and to compress edges of said first and second slots onto said flanges to secure said pipe support in a position on said strut.
